(19) United States
(12) Patent Application Publication
(10) Pub. No.: US 2018/0115099 A1
(43) Pub. Date: Apr. 26, 2018

(54) BOARD-TO-BOARD CONNECTOR

(71) Applicant: DAI-ICHI SEIKO CO., LTD., Kyoto-shi (JP)

(72) Inventors: Takayoshi Endo, Shizuoka-shi (JP); Hisashi Hamachi, Shizuoka-shi (JP)

(21) Appl. No.: 15/719,391

(22) Filed: Sep. 28, 2017

(30) Foreign Application Priority Data
Oct. 20, 2016 (JP) 2016-206007

(51) Int. Cl. H01R 12/77; H01R 13/193

(52) U.S. Cl. CPC H01R 12/778; H01R 12/79; H01R 13/193

(57) ABSTRACT

A board-to-board connector includes a male connector and a female connector. The female connector includes: a tubular part that includes a wall disposed in a tubular form along the thickness direction of FPC; and a spring that includes one end extending in an orthogonal direction orthogonal to the thickness direction of the FPC and the other end contiguous to the one end and urged toward the wall by the one end, the spring being disposed in the tubular part. In the female connector, a contact is disposed on the wall of the tubular part, while a contact is disposed on the other end of the spring so as to be opposed to the contact. In the state where the female connector is fitted into the male connector, the contact clamps a protruding terminal with the contact through the restoring force of the spring.

### CROSS-REFERENCE TO RELATED APPLICATION

This application claims the benefit of Japanese Patent Application No. 2016-206007, filed on Oct. 20, 2016, the entire disclosure of which is incorporated by reference herein.

### FIELD

This application relates to a board-to-board connector.

### BACKGROUND

A board-to-board connector including a first connector that is mounted on a first board and a second connector that is mounted on a second board and is fitted with the first connector has been proposed (see Patent Literature 1, for example). The first connector includes a protruding terminal that protrudes in the thickness direction of the first board, while the second connector includes a receiving terminal, part of which makes resilient contact with the protruding terminal laterally (in a direction orthogonal to the direction along which a male terminal protrudes). The receiving terminal includes a conductor that forms a terminal housing opening into which a protruding terminal is inserted, two arms that extend inward from an outer edge of the terminal housing opening in the conductor, and a protrusion that protrudes inward from an outer edge of the terminal housing opening in the conductor. The conductor, the two arms, and the protrusion are formed of metals having resilience. The two arms, with their bases connected to an outer edge of the terminal housing opening, are deformed in such a way that their tips are displaced in a direction orthogonal to the direction along which the protruding terminal is inserted.

To fit the second connector into the first connector, first, the first board and the second board are stacked in such a way that the protruding terminal is inserted near the base of one arm in the terminal housing opening of the receiving terminal. Then, the second board is slid on the first board so that the protruding terminal is moved to the tip of one arm in the terminal housing opening. As a result, the second connector is fitted into the first connector, with the protruding terminal clamped among the tips of two arms and a protrusion that are making resilient contact with the protruding terminal.

Patent Literature 1 Unexamined Japanese Patent Application Kokai Publication No. 2012-226977

### SUMMARY

The board-to-board connector described in Patent Literature 1, however, requires two steps to fit the second connector into the first connector: one step is stacking the first and second boards, and the other step is sliding the second board in contact with the first board. Consequently, the work efficiency in the step of connecting the first and second connectors may be lowered.

The present disclosure has been created in view of the foregoing circumstances, and an objective of the disclosure is to provide a board-to-board connector that achieves higher work efficiency in the step of coupling connectors.

To achieve the aforementioned objective, a board-to-board connector according to the present disclosure includes:

a first connector mounted on a first board, the first connector including a protruding terminal protruding in a thickness direction of the first board; and

a second connector mounted on a second board, the second connector including a first contact and a second contact being opposed to each other in an orthogonal direction orthogonal to a thickness direction of the second board,

wherein, when the second connector is fitted into the first connector, the protruding terminal of the first connector is inserted between the first contact and the second contact of the second connector,

wherein the second connector includes:

a tubular part including a wall disposed in a tubular form along the thickness direction of the second board; and

a spring including a first end extending in the orthogonal direction and a second end contiguous to the first end and urged toward the wall by the first end, the spring being disposed in the tubular part,

wherein the first contact is provided on the wall of the tubular part, and

wherein the second contact is provided on the second end of the spring so as to be opposed to the first contact, the second contact clamping the protruding terminal with the first contact through a restoring force of the spring, in a state where the second connector is fitted into the first connector.

According to the present disclosure, a tubular part including a wall disposed in a tubular form along the thickness direction of a second board; and a spring including a first end extending in an orthogonal direction orthogonal to the thickness direction of the second board and a second end contiguous to the first end and urged toward the wall by the first end, the spring being disposed in the tubular part, are included. The first contact is provided on the wall in the tubular part, while the second contact is provided on the second end of the spring so as to be opposed to the first contact. Hence, carrying out the step of fitting the second connector into the first connector in such a way that a protruding terminal is inserted between the first contact and the second contact establishes connection between the first connector and the second connector. Therefore, the work efficiency in the step of connecting the first connector and the second connector is improved.

### BRIEF DESCRIPTION OF THE DRAWINGS

A more complete understanding of this application can be obtained when the following detailed description is considered in conjunction with the following drawings, in which:

FIG. 1A is a perspective view of a board-to-board connector according to an embodiment of the present disclosure, illustrating the state where a female connector is unmated from a male connector;

FIG. 1B is a perspective view of the board-to-board connector according to the embodiment, illustrating the state where the female connector is mated with the female connector;

FIG. 2A is a plan view of the male connector according to the embodiment;

FIG. 2B is a perspective view of the male connector according to the embodiment;

FIG. 3 is an exploded perspective view of the female connector according to the embodiment;

FIG. 4A is a perspective view of a female terminal according to the embodiment, seen from one direction;

FIG. 4B is a perspective view of the female terminal according to the embodiment, seen from another direction;

FIG. 5A is a diagram intended to explain a tube axis of a tubular part in the female terminal according to the embodiment;

FIG. 5B is a plan view of the female terminal according to the embodiment;

FIG. 6A is a cross-sectional view illustrating the state where the female connector is unmated from the male connector according to the embodiment;

FIG. 6B is a cross-sectional view illustrating the state where the female connector is in the process of mating with the male connector according to the embodiment;

FIG. 6C is a cross-sectional view illustrating the state where the female connector is mated with the male connector according to the embodiment;

FIG. 7A is a perspective view illustrating the state where a protruding terminal is unmated from the female terminal according to the embodiment;

FIG. 7B is a perspective view illustrating the state where the protruding terminal is clamped in the female terminal according to the embodiment;

FIG. 8A is a perspective view of a female terminal according to a variation;

FIG. 8B is a plan view of the female terminal according to the variation; and

FIG. 9 is a plan view of a female terminal according to a variation.

### DETAILED DESCRIPTION

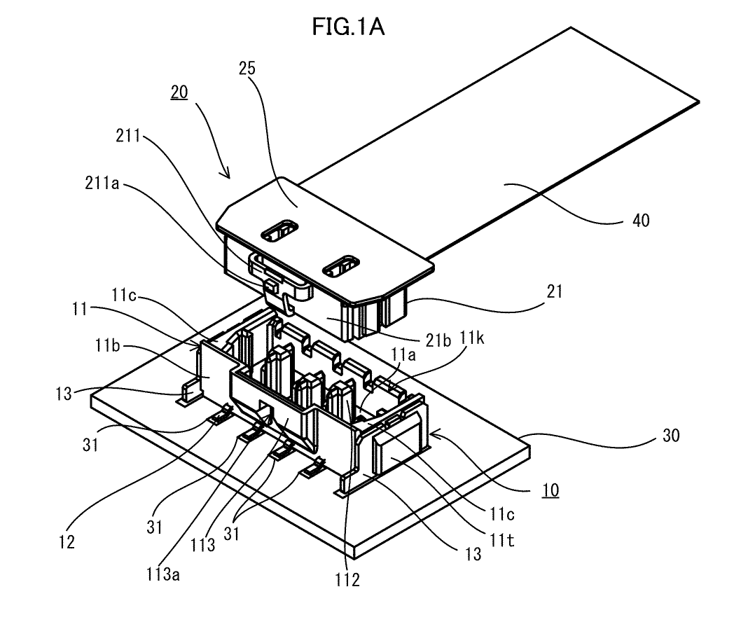

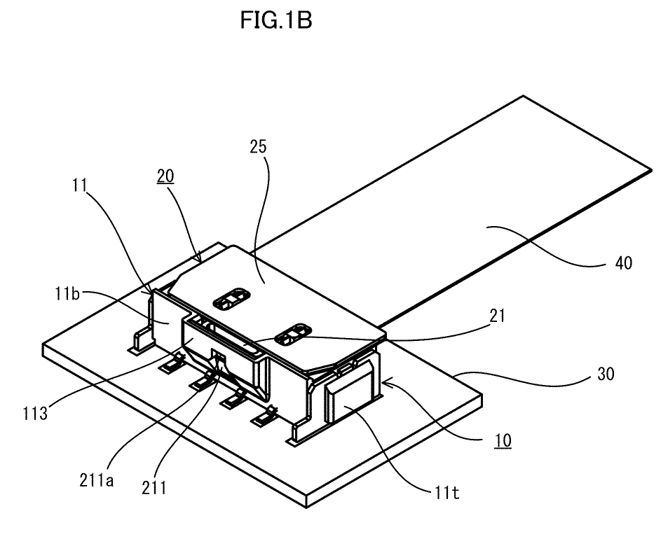

A board-to-board connector according to one embodiment of the present disclosure will now be described with reference to the drawings. The board-to-board connector according to the present embodiment is intended for connection between flexible printed circuits (hereinafter called “FPC”) and another circuit board. As illustrated in FIGS. 1A and 1B, the board-to-board connector includes a male connector (first connector) 10 mounted on a circuit board (first board) 30 and a female connector (second connector) 20 connected to FPC (second board) 40. The male connector 10 includes a male connector housing 11, two metal fittings 13, and a plurality of (four in FIG. 1A) male terminals 12.

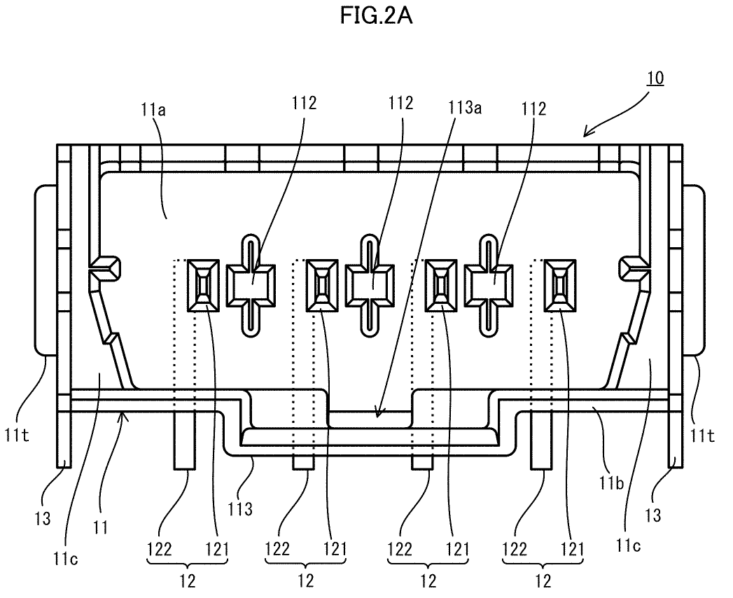

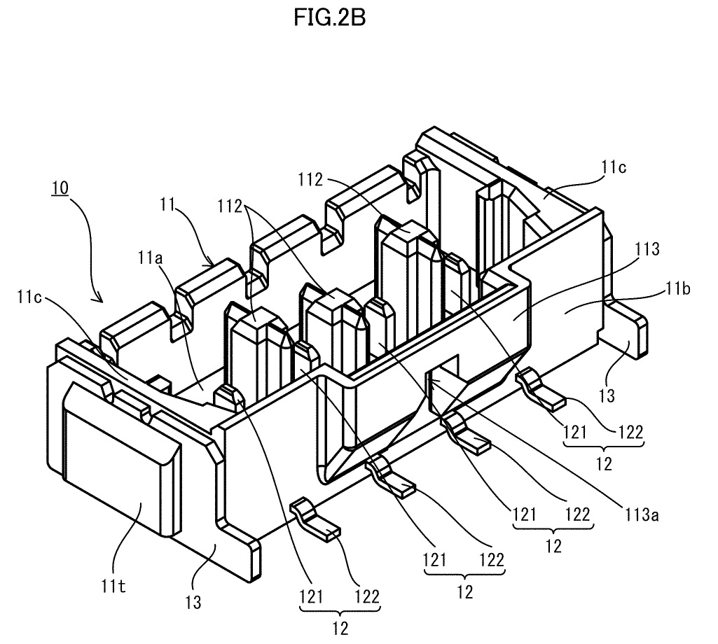

The male connector housing 11 includes an opening 11k into which the female connector 20 is to be inserted. The male connector housing 11 is formed of a resin material through, for example, injection molding. As illustrated in FIGS. 2A and 2B, three guide ribs 112 for guiding the female connectors 20 are disposed on a bottom wall 11a of the male connector housing 11. On one side wall 11b with respect to the transverse direction of the male connector housing 11, a protrusion 113 protruding outward is disposed. A fitting hole 113a is formed at the center of the protrusion 113. A projection 211a of a fixing part 211, which is described below, is to be fitted into the fitting hole 113a. On each side wall 11c with respect to the longitudinal direction of the male connector housing 11, a metal fitting holder 11t is disposed for holding the metal fitting 13 on the side wall 11c.

The metal fittings 13 are intended to fasten the side walls 11c of the male connector housing 11 to the circuit board 30. The metal fittings 13 are disposed to abut on the side walls 11c in such a way as to be held by the metal fitting holders 11t disposed on the side walls 11c of the male connector housing 11. The metal fitting 13 is formed by, for example, blanking a metal plate. The metal fitting 13 is soldered to a soldering part formed on the circuit board 30, so that the male connector 10 is mounted on the circuit board 30.

The male terminal 12 is an L-shaped terminal including a pillar-like protruding terminal 121 protruding in the thickness direction of the circuit board 30, as well as including a connecting terminal 122 extending from the base of the protruding terminal 121 in a direction orthogonal to the protruding direction of the protruding terminal 121. The male terminal 12 is formed of an electrically conductive material such as metal. The protruding terminal 121 is disposed so as to protrude from the bottom wall 11a inside the male connector housing 11 in the thickness direction of the circuit board 30. The connecting terminal 122 is fastened to the male connector housing 11 in such a way that part of the connecting terminal is embedded in the bottom wall 11a of the male connector housing 11, with the tip of the connecting terminal 122 located outside the side wall of the male connector housing 11. The connecting terminal 122 is soldered to a conductor pattern 31 formed on the circuit board 30, so that the connecting terminal 122 is electrically connected to the conductor pattern 31.

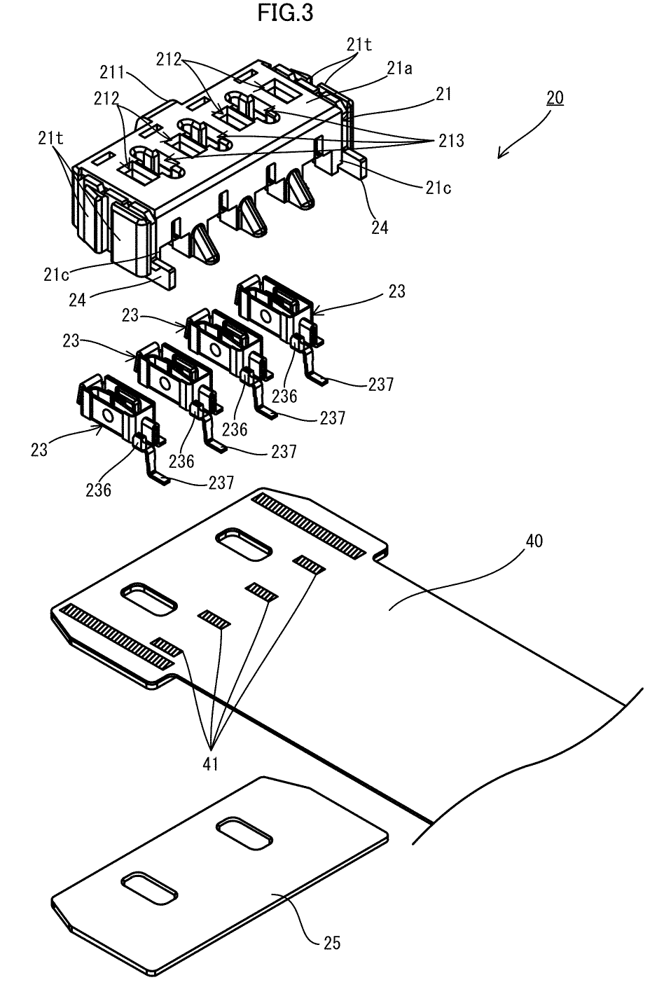

As illustrated in FIG. 3, the female connector 20 includes a female connector housing 21, a plurality of (four in FIG. 3) female terminals 23, two metal fittings 24, and an FPC reinforcing plate 25.

The female connector housing 21 is in the form of a rectangular box, and on a top face 21a are disposed a plurality of (four in FIG. 3) terminal insertion holes 212 into which the protruding terminals 121 of the male connector 10 are to be inserted, and rib insertion holes 213 into which the three guide ribs 112 are to be individually inserted. The female connector housing 21 is formed of a resin material through, for example, injection molding. The outside dimensions of the female connector housing 21 in a planar view are smaller than the dimensions of the opening 11k of the male connector housing 11. As illustrated in FIG. 1B, the female connector 20 is connected to the male connector 10 in such a way that the female connector housing 21 is fitted into the male connector housing 11. As illustrated in FIG. 1A, on one side wall 21b with respect to the transverse direction of the female connector housing 21, a fixing part 211 is disposed to fix the female connector 20 on the male connector 10. Furthermore, on the fixing part 211 is formed a projection 211a, which is to be fitted into the fitting hole 113a in the male connector housing 11 when the female connector 20 is completely fitted into the male connector 10, as illustrated in FIG. 1B. As depicted in FIG. 3, on each side wall 21c with respect to the longitudinal direction of the female connector housing 21, a metal fitting holder 21t is disposed for holding the metal fitting 24 on the side wall 21c.

The metal fittings 24 are intended to fasten the side walls 21c of the female connector housing 21 to the FPC 40. As illustrated in FIG. 3, the metal fittings 24 each are disposed to abut on the side wall 21c in such a way that the metal fitting is held by the metal fitting holder 21t disposed on the side wall 21c of the female connector housing 21. The metal fitting 24 is formed by, for example, blanking a metal plate. The metal fitting 24 is soldered to a soldering part formed on the FPC 40, so that the female connector 20 is mounted on the FPC 40.

The FPC reinforcing plate 25 is provided for reinforcing the area where the FPC 40 is attached on the female connector housing 21. The FPC reinforcing plate 25 is disposed on a face of the FPC 40 opposite to the face on which the female connector housing 21 is disposed, and the FPC 40 is clamped between the FPC reinforcing plate 25 and the female connector housing 21. The FPC reinforcing plate 25 is formed by, for example, blanking a metal plate.

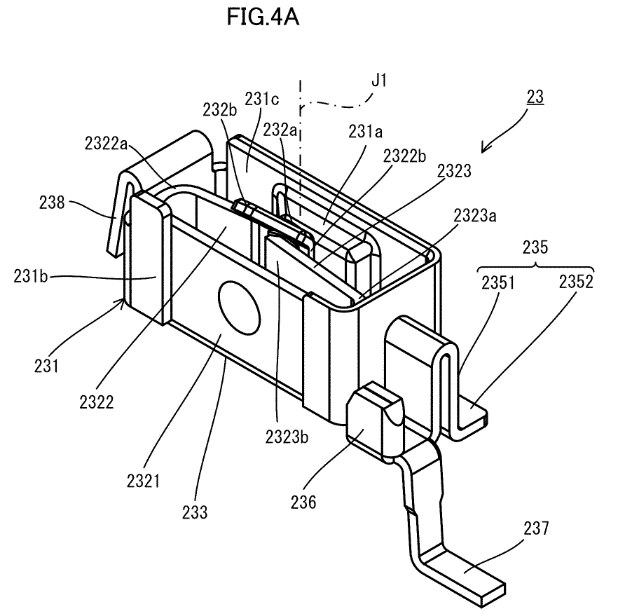

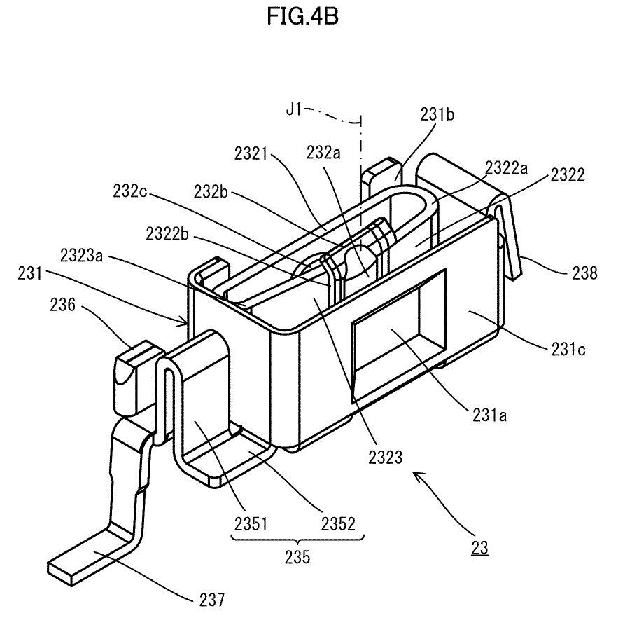

As illustrated in FIGS. 4A and 4B, the female terminal 23 includes a tubular part 231, a spring 2322, an auxiliary spring 2323, a cushion 235, fixing parts 236 and 238, and a connecting terminal 237. The female terminal 23 is formed of an electrically conductive material such as metal.

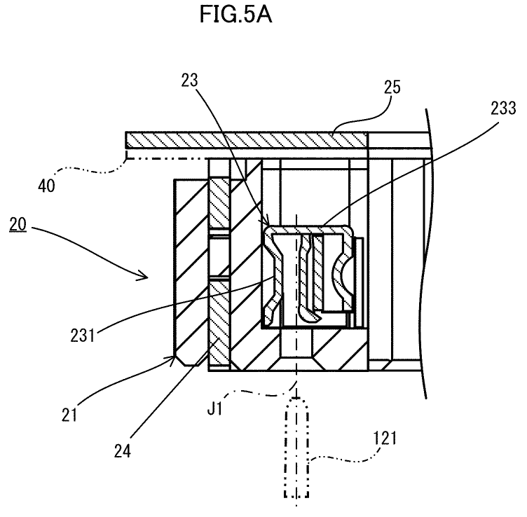

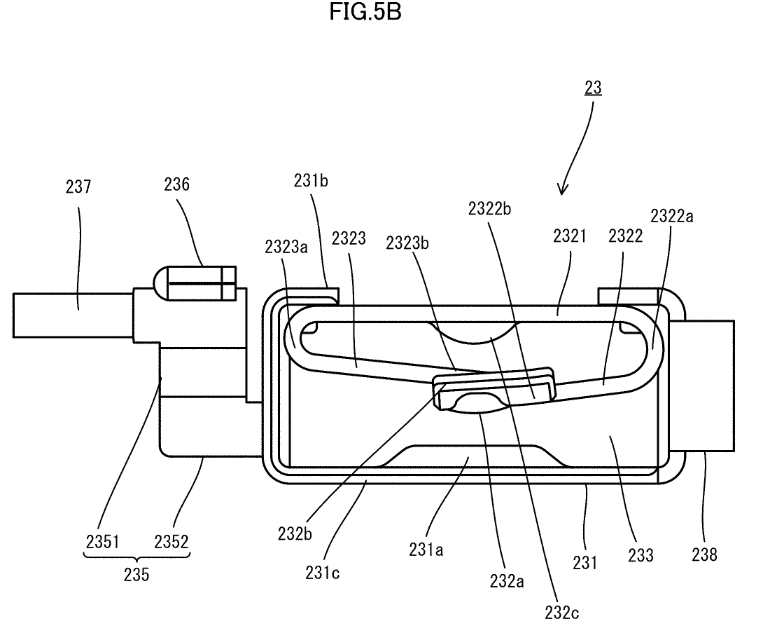

The tubular part 231 is a bottom-closed rectangular tube, and is placed so that its tube axis J1 runs parallel to the thickness direction of the FPC 40, as indicated in FIG. 5A. As illustrated in FIG. 5B, the tubular part 231 includes a support piece 2321 being in a rectangular plate and supporting both the spring 2322 and the auxiliary spring 2323. At the center of the support piece 2321 is disposed a deformation preventing part 232c, which projects toward the spring 2322 and the auxiliary spring 2323 to be able to abut on an end of the auxiliary spring 2323. As a result, the spring 2322 and the auxiliary spring 2323 are prevented from excessively deforming.

On a side wall 231c of the tubular part 231 is disposed a contact (first contact) 231a, which is in the form of a projection toward a contact (second contact) 232a on the spring 2322, which is described below. The contact 231a is disposed in an area on the side wall 231c of the tubular part 231, the area facing the contact (second contact) 232a on the spring 2322. That is, the two contacts 231a and 232a are opposed to each other in an orthogonal direction orthogonal to the thickness direction of the FPC 40.

The spring 2322 is formed of a metal plate spring. As illustrated in FIGS. 4A and 4B, the spring 2322, which is disposed inside the tubular part 231, is formed integrally with the support piece 2321 in the tubular part 232 and extends in an orthogonal direction orthogonal to the tube axis J1 in the tubular part 231. The spring 2322 is fastened to the support piece 2321 in such a way that one end (first end) 2322a of the spring 2322 with respect to the longitudinal direction is formed integrally with the support piece 2321. The spring 2322 urges the other end (second end) 2322b with respect to the longitudinal direction toward the side wall 231c of the tubular part 231. As illustrated in FIG. 4B, the contact 232a is provided on the other end 2322b of the spring 2322. The contact 232a is in the form of a projection toward the contact 231a on the tubular part 231. On the contact 232a is provided a tongue piece (guide) 232b, which guides the protruding terminal 121 of the male connector 10 between the two contacts 231a and 232a when the female connector 20 is being fitted into the male connector 10. The tongue piece 232b extends from the contact 232a outward on the side opposite to the FPC 40, being inclined relative to the thickness direction of the FPC 40.

The auxiliary spring 2323, which is formed of a metal plate spring, urges the contact 232a on the spring 2322 toward the contact 231a on the tubular part 231. The auxiliary spring 2323 is fastened to the support piece 2321 in such a way that one end (third end) 2323a of the auxiliary spring 2323 with respect to the longitudinal direction is formed integrally with the support piece 2321. The other end (fourth end) 2323b of the auxiliary spring 2323 with respect to the longitudinal direction makes resilient contact with, or is adjacent to, the side opposite to the side of the other end 2322b of the spring 2322 where the contact 232a is provided.

The fixing parts 236 and 238 are provided for fixing the female terminal 23 on the female connector housing 21. The fixing part 236 is formed integrally with the cushion 235. The fixing part 238 is formed integrally with the tubular part 231. The fixing part 236 is press-fitted into a fixing hole (not illustrated) formed on an inner wall of the female connector housing 21, while the fixing part 238 is engaged with an engagement piece (not illustrated) disposed inside the female connector housing 21. The fixing part 238 is engaged with the engagement piece slidably along the engagement piece in the transverse direction of the tubular part 231.

The connecting terminal 237 is connected to the tubular part 231 via the cushion 235. The cushion 235, which is a U-shaped curved plate, includes a bend 2351, which is connected to the connecting terminal 237, and a link 2352, which is formed into a plate and links the bend 2351 to the tubular part 231. Note that, when the bend 2351 of the cushion 235 deforms, the tubular part 231 can move along the transverse direction of the tubular part 231 relative to the connecting terminal 237 fastened to the FPC 40. The connecting terminal 237 is soldered to a conductor pattern 41 formed on the FPC 40 (see FIG. 3), so that the connecting terminal 237 is electrically connected to the conductor pattern 41.

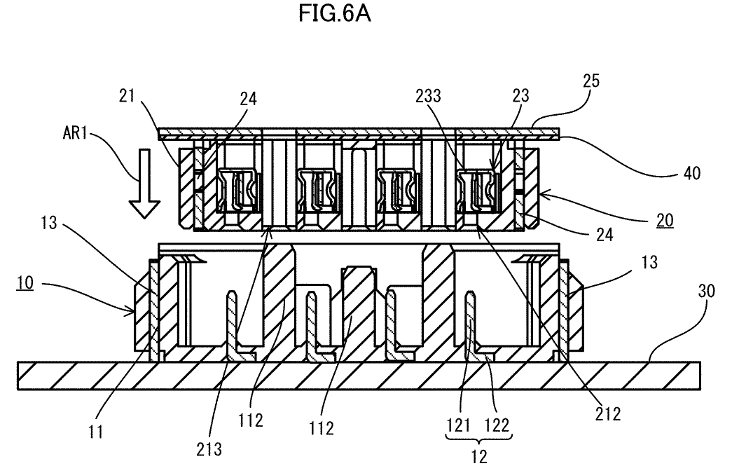

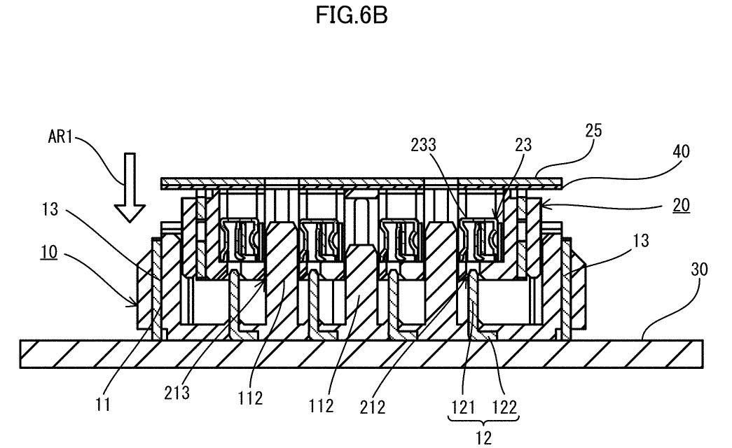

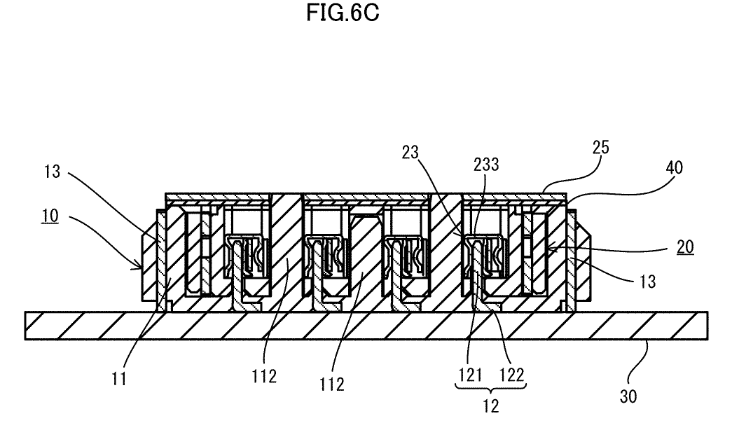

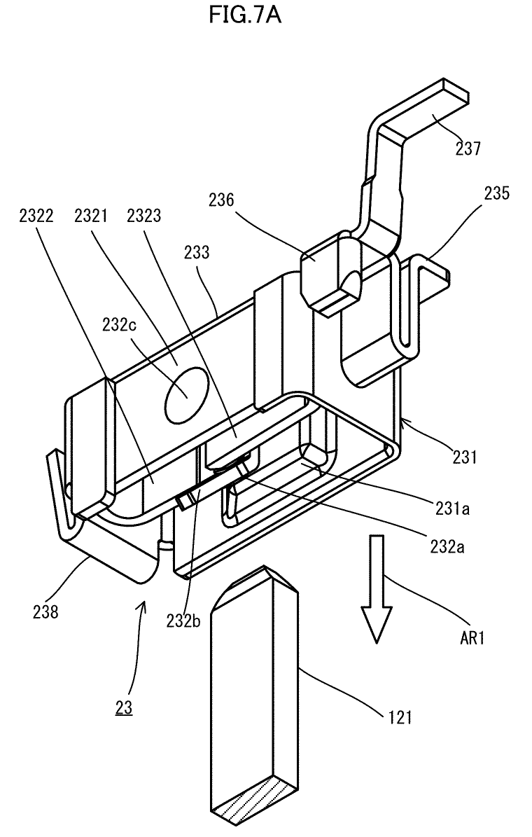

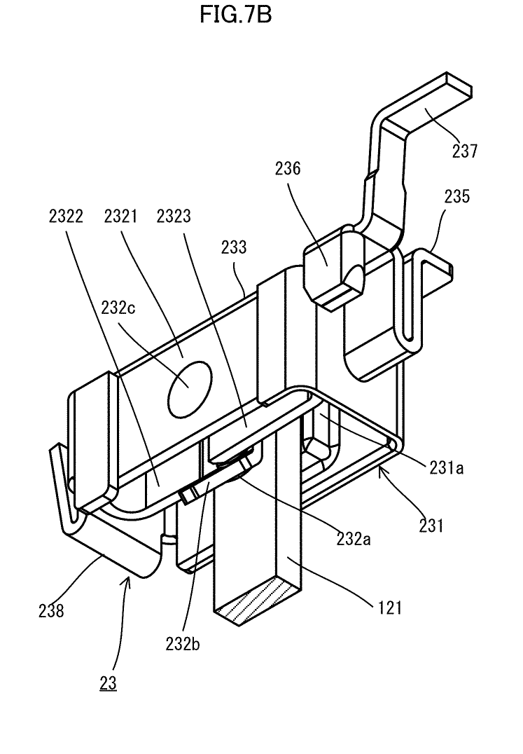

A method for connecting the female connector 20 to the male connector 10 according to the present embodiment will now be described in detail. First, as indicated by an arrow AR1 in FIG. 6A, the female connector 20 is brought closer to the male connector 10 toward the opening 11k in the male connector housing 11. Next, as illustrated in FIG. 6B, the tip of the guide rib 112 in the male connector 10 is inserted into the rib insertion hole 213 in the female connector housing 21, and then the female connector 20 is moved toward the circuit board 30 (see the arrow AR1 in FIG. 6B). Accordingly, as the female connector 20 is guided by the guide rib 112, the tip of the protruding terminal 121 comes closer to the female terminal 23. At this point of time, as indicated by the arrow AR1 in FIG. 7A, the tip of the protruding terminal 121 comes closer to a region between the two contacts 231a and 232a of the female terminal 23. Then, when the female connector 20 is pressed toward the circuit board 30, as illustrated in FIG. 6C, the female connector 20 is fitted into the male connector 10, establishing the state where the protruding terminal 121 is connected to the female terminal 23. At the same time, as illustrated in FIG. 7B, the protruding terminal 121 is inserted between the two contacts 231a and 232a of the female terminal 23, and these two contacts 231a and 232a clamp the protruding terminal 121 through the restoring force of the spring 2322. Also at the same time, as illustrated in FIG. 1B, the fixing part 211 of the female connector 20 is inserted inside the protrusion 113 of the male connector housing 11, and the projection 211a on the fixing part 211 is fitted into the fitting hole 113a in the male connector housing 11. Consequently, when an external force is applied to the female connector 20 in the direction of separating from the male connector 10, the female connector 20 is prevented from separating from the male connector 10.

As described above, the female connector 20 in the board-to-board connector according to the present embodiment includes the tubular part 231 and the spring 2322. The tubular part 231 has the tube axis J1 running parallel to the thickness direction of the FPC 40. The spring 2322, which extends in an orthogonal direction orthogonal to the thickness direction of the FPC 40, is fastened to the support piece 2321 in such a way that the one end 2322a is formed integrally with the support piece 2321, and urges the other end 2322b toward the side wall 231c of the tubular part 231. In addition, the contact 232a is provided on the other end 2322b of the spring 2322, while the contact 231a is provided on the tubular part 231 in an area facing the contact 232a. Hence, carrying out the step of fitting the female connector 20 into the male connector 10 in such a way that the protruding terminal 121 is inserted between the contacts 231a and 232a along the direction of the tube axis J1 of the tubular part 231 establishes connection between the male connector 10 and the female connector 20. Therefore, the work efficiency in the step of connecting the female connector 20 and the male connector 10 is improved.

In the female terminal 23 according to the present embodiment, the tube axis J1 of the tubular part 231 runs parallel to the thickness direction of the FPC 40, while the spring 2322 extends in an orthogonal direction orthogonal to the thickness direction of the FPC 40. That is, the spring 2322 extends in a direction orthogonal to the tube axis J1 of the tubular part 231. Hence, the spring 2322 can be elongated to have a larger resilient region, by increasing the cross-sectional area of the tubular part 231 without changing the height of the tubular part 231 along the tube axis J1. Therefore, the protruding terminal 121, which is to be inserted between the contacts 231a and 232a in the female connector 20, can have a wider acceptable range of thickness values, and eventually, the versatility of the female connector 20 can be increased.

In addition, in the female terminal 23 according to the present embodiment, the spring 2322 is disposed inside the tubular part 231. Hence, the support piece 2321 supporting the spring 2322 is prevented from being distant from the side wall 231c, and the contact pressure between the contacts 231a and 232a can be stabilized.

The female terminal 23 according to the present embodiment includes the auxiliary spring 2323 urging the contact 232a toward the contact 231a. Hence, when the protruding terminal 121 of the male terminal 12 is inserted between the contacts 231a and 232a, a higher contact pressure can be applied to the protruding terminal 121 between the contacts 231a and 232a. Therefore, connection failures among the contacts 231a and 232a and the protruding terminal 121 can be prevented.

Furthermore, in the female terminal 23 according to the present embodiment, the contact 232a includes the tongue piece 232b, which guides the protruding terminal 121 between the contacts 231a and 232a when the female connector 20 is going to be fitted into the male connector 10. Hence, the protruding terminal 121 is smoothly inserted between the two contacts 231a and 232a when the female connector 20 is going to be fitted into the male connector 10. Therefore, the female connector 20 and the male connector 10 can be easily connected.

The tubular part 231 according to the present embodiment has a closed bottom. Hence, ends of side walls (for example, the side walls 231b and 231c) are linked by the bottom wall 233 of the tubular part 231, thereby providing the advantage that the strength of the tubular part 231 is increased. In addition, the contacts 231a and 232a can be prevented from being damaged by the user unintentionally touching the spring 2322 or the auxiliary spring 2323.

### (Variations)

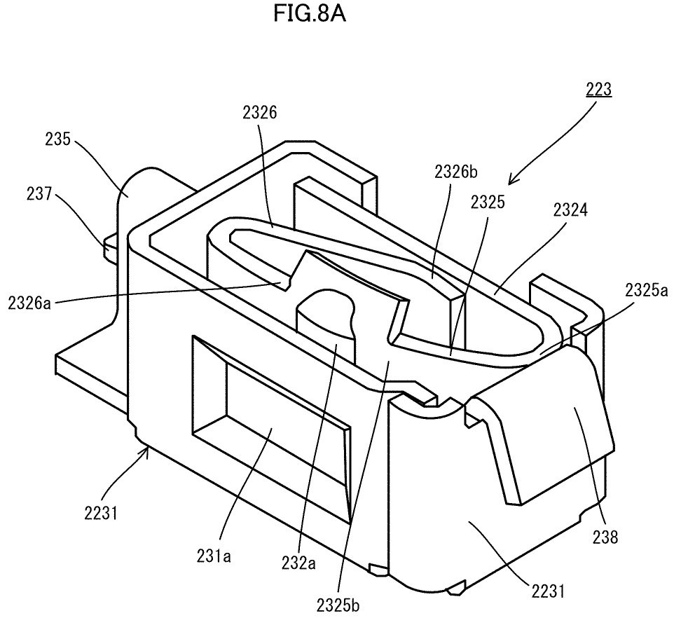

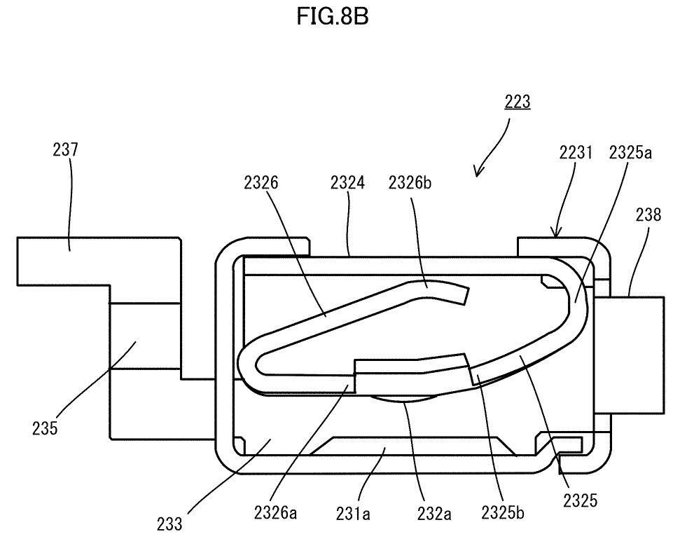

Embodiments of the present disclosure have been described above, but the present disclosure is not limited to the configurations of the foregoing embodiments. For example, as illustrated in FIGS. 8A and 8B, the auxiliary spring 2326 may be formed into a V-shaped curve in a plane along an orthogonal direction orthogonal to the tube axis J1 of the tubular part 2231. Note that, in FIGS. 8A and 8B, symbols identical to those in FIGS. 4A, 4B and 5B are given to components similar to those in the embodiments. The spring 2325 is fastened to the support piece 2324 in such a way that one end 2325a of the spring 2325 with respect to the longitudinal direction is formed integrally with the support piece 2324. One end 2326a of the auxiliary spring 2326 with respect to the longitudinal direction is connected to the other end (first end) 2325b of the spring 2325 with respect to the longitudinal direction, while the other end 2326b of the auxiliary spring 2326 with respect to the longitudinal direction makes resilient contact with, or is adjacent to, the support piece 2324.

According to this configuration, when the step of fitting the female connector into the male connector is carried out in such a way that the protruding terminal 121 is inserted between the contacts 231a and 232a along the direction of the tube axis J1 of the tubular part 231, connection between the male connector and the female connector is established, as in the embodiments. Therefore, this configuration also improves the work efficiency in the step of connecting the female connector to the male connector, as in the embodiments.

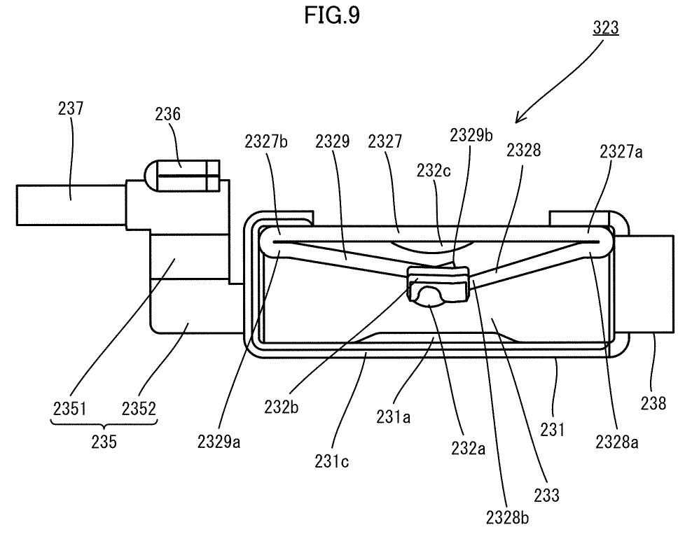

According to examples described in the embodiments, as seen in FIG. 5B, the one end 2322a integrated with the support piece 2321 for the spring 2322 and the one end 2323a integrated with the support piece 2321 for the auxiliary spring 2323 each are curved to be C-shaped. However, the one end 2322a of the spring 2322 and the one end 2323a of the auxiliary spring 2323 are not limited to such shape. For example, as illustrated in FIG. 9, the spring 2328 may be folded in such a way that the one end 2328a integrated with the support piece 2327 is put on one end 2327a of the support piece 2327. Likewise, the auxiliary spring 2329 may be folded in such a way that the one end 2329a integrated with the support piece 2327 is put on one end 2327b of the support piece 2327. Note that, in FIG. 9, symbols identical to those in FIG. 5B are given to components similar to those in the embodiments. The spring 2328 and the auxiliary spring 2329 include their respective flexible portions shorter than those of the spring 2322 and the auxiliary spring 2323 of the embodiments. Accordingly, the distance between the deformation preventing part 232c and the other ends 2328b and 2329b of the spring and auxiliary spring 2328 and 2329 is shorter. As a result, the female terminal 323 accepts between the contacts 231a and 232a a protruding terminal in a more restrictive size than those accepted by the female terminal 23 according to the embodiments.

According to this configuration, the female terminal 323 accepts a protruding terminal in a restrictive size inserted between the contacts 231a and 232a, and thus limited types of male terminals can be connected to the male terminal. Therefore, this configuration can prevent equipment malfunctions or accidents arising out of, for example, a connection between the female terminal 323 and a wrong male terminal (for example, the male terminal to be mated with the female terminal 23) not conforming to the specifications. In addition, according to this configuration, the spring 2328 is folded in such a way that the one end 2328a is put on the end 2327a of the support piece 2327, while the auxiliary spring 2329 is folded in such a way that the one end 2329a is put on the end 2327b of the support piece 2327. This provides an additional advantage that the female terminal 323 can be smaller because of the shorter distance between the support piece 2327 and the side wall 231c of the tubular part 231.

According to examples described in the embodiments, the spring 2322 and the auxiliary spring 2323 are formed integrally with the support piece 2321 of the tubular part 231. However, this is not the only option, and the spring 2322 and the auxiliary spring 2323 may be separated from the support piece 2321.

According to examples described in the embodiments, the auxiliary spring 2323 is formed of a metal plate spring, but types of the auxiliary spring 2323 are not limited to metal plate springs. For example, the auxiliary spring 2323 may be formed of a coil spring. Alternatively, the auxiliary spring 2323 may be formed of a spring made from a resin.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The board-to-board connector according to the present disclosure is widely utilized in fields including the electric and electronic equipment industry and the automotive industry.

What is claimed is:

1. A board-to-board connector comprising:
a first connector mounted on a first board, the first connector comprising a protruding terminal protruding in a thickness direction of the first board; and
a second connector mounted on a second board, the second connector comprising a first contact and a second contact being opposed to each other in an orthogonal direction orthogonal to a thickness direction of the second board,
wherein, when the second connector is fitted into the first connector, the protruding terminal of the first connector is inserted between the first contact and the second contact of the second connector,
wherein the second connector comprises:
a tubular part comprising a wall disposed in a tubular form along the thickness direction of the second board; and
a spring comprising a first end extending in the orthogonal direction and a second end contiguous to the first end and urged toward the wall by the first end, the spring being disposed in the tubular part,
wherein the first contact is provided on the wall of the tubular part, and
wherein the second contact is provided on the second end of the spring so as to be opposed to the first contact, the second contact clamping the protruding terminal with the first contact through a restoring force of the spring, in a state where the second connector is fitted into the first connector.

2. The board-to-board connector according to claim 1, wherein the second connector further comprises an auxiliary spring that is disposed in the tubular part and urges the second contact toward the first contact.

3. The board-to-board connector according to claim 2, wherein the auxiliary spring comprises a third end extending in the orthogonal direction and disposed to be opposed to the first end and contiguous to the third end, extending toward the second end, and urging the second contact toward the first contact.

4. The board-to-board connector according to claim 2, wherein the auxiliary spring is in a form of a V-shaped curve in a plane along the orthogonal direction, one end of the auxiliary spring is connected to the second end of the spring, and another end of the auxiliary spring extends toward a wall surface opposite to the wall surface on which the first contact is provided.

5. The board-to-board connector according to claim 1, further comprising:
a guide that is disposed on at least one of the first contact or the second contact, and that guides the protruding terminal between the first contact and the second contact when the first connector is being fitted into the second connector.

6. The board-to-board connector according to claim 5, wherein the guide comprises a tongue piece that extends from at least one of the first contact or the second contact outward on a side opposite to a side of the second board and that is inclined with respect to the thickness direction of the second board.

7. The board-to-board connector according to claim 1, wherein the tubular part comprises a closed bottom.

8. The board-to-board connector according to claim 1, wherein the first contact and the second contact project toward each other.
